(19) United States
(12) Patent Application Publication
(10) Pub. No.: US 2012/0280856 A1
(43) Pub. Date: Nov. 8, 2012

(54) RADAR

(76) Inventor: Gordon Oswald, Huntingdon (GB)

(21) Appl. No.: 13/497,530

(22) PCT Filed: Sep. 21, 2010
(86) PCT No.: PCT/GB2010/051587

§ 371 Date: Jul. 27, 2012

(30) Foreign Application Priority Data
Sep. 21, 2009 (GB) 0916556.4

(51) Int. Cl. G01S 7/03; G01S 7/40

(52) U.S. Cl. 342/174; 342/175

(57) ABSTRACT

A radar receiver having an antenna. The antenna has an array of antenna elements. The receiver also includes a number of processing stages including a first processing stage adapted to process radar signals received via each antenna element of the array and a second processing stage adapted to serve the first processing stage. The processing stages are each arranged substantially parallel to one another, and to the antenna substrate.

The present invention relates to a radar receiver and in particular, but not limited to, a receiver of a phased array radar or more specifically a receiver of an active phased array radar arranged for holographic operation.

Active Phased Array Radar (APAR) is a technique used for advanced surveillance and tracking functions. In a typical APAR, the radar comprises a number of transmit-receive modules. These act together and incorporate accurate amplitude and phase or delay control equipment so that a beam may be formed by the transmitter modules, and the same beam subsequently used to detect targets located in a particular direction from the radar.

Such systems are, however, expensive to construct and complex to control—in particular the phase and amplitude of each transmitting and receiving element must be controlled. Control must be maintained at very different power levels (on transmission and on reception), over the full temperature range and under conditions of stress and vibration. Should any element or module fail, the radar must be recalibrated.

In another implementation of active phased array radar, known as holographic radar, a transmitter is used to illuminate a broad field of view rather than a narrow beam. In this case receive-only modules are used. However, these also require accurate phase or delay control, to form beams for reception and accordingly require relatively complex circuitry. Furthermore, for optimum performance, the circuitry required for each receiver channel (of which there may be many) must be configured to ensure a high degree of uniformity across all receiver channels.

Accordingly the present invention provides an improved radar receiver, and improved methods for operating, calibrating and fabricating a radar receiver.

International Patent Application having publication number WO97/14058, which names Cambridge Consultants Ltd as patent applicant and whose disclosure is incorporated by reference, discloses apparatus for and method of determining positional information for an object, including a method for determining the position of an object by means of detecting the relative timing of probe signals returned by said object at a plurality of spaced apart locations.

### Parallel Processing Stages

According to one aspect of the invention there is provided a radar receiver, the receiver comprising: at least one antenna comprising an array of antenna elements; a first processing stage adapted to process radar signals received via each antenna element of said array; and a second processing stage adapted to serve the first processing stage; wherein said first and second processing stages are each arranged substantially parallel to one another, and to said antenna substrate.

### Modular Hierarch

The at least one antenna may be arranged in a plurality of groups (e.g. sub-arrays), wherein each group (e.g. sub-array) preferably comprises a plurality of antenna elements; and wherein the first processing stage preferably comprises a plurality of processing modules, each processing module preferably being adapted to process radar signals received by a different said group of antenna elements.

The or each module of said first processing stage may be adapted to process radar signals received by a group comprising M antenna elements wherein M is preferably an integer power of 2, preferably an integer power of 4, and more preferably 4.

The second processing stage may comprise at least one processing module, the or each processing module preferably being adapted to serve at least one, preferably a plurality, of said processing modules of the first processing stage.

The or each module of said second processing stage may be adapted to serve N modules of the first processing stage wherein N is preferably an integer power of 2, preferably an integer power of 4, advantageously 4.

Thus, according to another aspect of the invention, there is provided a radar receiver, the receiver comprising: at least one antenna comprising an array of antenna elements arranged in a plurality of groups (e.g. sub-arrays); a first processing stage comprising a plurality of processing modules, each processing module being adapted to process radar signals received by a different said group of antenna elements of said array; and a second processing stage comprising at least one processing module, the or each processing module being adapted to serve a plurality of said processing modules of the first processing stage; wherein said first and second processing stages are each arranged substantially parallel to one another, and to said antenna substrate.

Advantageously, this provides benefits over the use of, for example, a ‘tiled’ structure for the design of a phased array radar (in which some of the processing elements for a rectangular section of the antenna are arranged in a sub-array parallel to the plane of the antenna).

In particular, for example, the hierarchical symmetry and modular nature of this architecture provides inherent benefits in terms of scalability allowing the same basic architecture to be used even if the different functional circuit modules of the different processing stages scale at different rates (e.g. relative to the wavelength of the radar signals that the receiver is designed to receive and process). For example, RF and IF modules scale approximately directly with receiver antenna area, especially where printed filter or delay elements are to be used, whilst the size of timing control circuitry remains approximately constant.

The symmetry of the hierarchical modular architecture is also particularly beneficial in supporting the maintenance of accurate timing relationships between the various antenna elements, regardless of the band in which the receiver is designed to operate and the relative sizes of the different circuit modules.

In tiled designs, the different rates at which receiver circuitry scales with wavelength can cause difficulties for circuit designers which can result in designs which make inefficient use of circuit board real estate and/or have varying or non-optimal signal path length between different antenna elements and different parts of the receiver circuitry.

The or each processing module of the second processing stage may be adapted to serve a plurality of said processing modules of the first processing stage by providing a timing and/or control signal to each said processing module of the first processing stage.

The timing and/or control signal may bet provided to each said processing module of the first processing stage preferably via a different respective connection, each said connection preferably having substantially equal path length to each other said connection.

The or each processing module of the second processing stage may be adapted to serve a plurality of said processing modules of the first processing stage, and the or each processing module of the second processing stage may be positioned substantially centrally relative to the plurality of processing modules which it serves.

The first processing stage may comprise at least four first stage processing modules each of which may serves at least four antenna elements. The second processing stage may comprise at least four second stage processing modules each of which may serve at least four first stage processing modules (and may therefore serve 16 antenna elements).

The radar receiver according may comprise a further processing stage (e.g. a timing control stage). The further processing stage may be adapted to (or may comprise at least one further stage processing module adapted to) serve at least four second stage processing modules (and the further processing stage or module may therefore serve 64 antenna elements).

The radar receiver may comprise a hierarchy of processing stages which may each comprise one or more functionally equivalent processing modules. The processing modules at the highest level in the hierarchy preferably serves 4 antenna elements. A processing stage at a lower level in the hierarchy preferably serves 4 modules of a processing stage at a higher level of the hierarchy. Accordingly, the radar receiver may comprise a 4×4×4 . . . module scaling sequence between lower levels (further from the antenna elements) of the hierarchy and higher levels (nearer the antenna elements).

### Vertical Screening

The first and/or second processing stage may be provided on a substrate that is adapted to provide shielding from interference.

### Modular Screening

The first processing stage preferably comprises: a plurality of processing modules, each processing module of said first stage preferably being adapted to process radar signals received by said antenna. The second processing stage preferably comprises at least one processing module that may be adapted to serve at least one, preferably a plurality, of said processing modules of the first processing stage.

Each module of said first processing stage (and/or each module of said second processing stage) may be arranged on a different respective substrate.

Each module of each respective processing stage may be arranged in substantially the same plane as each other module of the respective processing stage.

Each module of said first processing stage (and/or each module of said second processing) may be provided with means for screening the or each said module from interference (e.g. from each other).

Said processing stages may be provided in a housing and the screening means may comprise at least part of said housing (e.g. a structural part).

Each module may be fabricated on a substrate and the screening means may comprise at least part of said substrate.

### Calibration Network

The at least one antenna may comprise a plurality of antenna elements arranged on a common antenna substrate; the radar receiver may further comprise means for providing a common calibration signal to each said antenna element; the calibration means may comprise a plurality of couplers provided on the common antenna substrate (or in a processing stage for the antenna); and each coupler may be arranged for coupling to a respective antenna element whereby to provide said calibration signal.

In a variation of the calibration network the radar receiver may comprise means for providing a common calibration signal to each said antenna element; the calibration means may comprise a plurality of couplers provided in one of said processing stages (for example, the first processing stage); and each coupler may be arranged for coupling to a connection from the processing stage to a respective antenna element whereby to provide said calibration signal.

The calibration means may be adapted to provide a common calibration signal preferably comprising at least one of: a pre-determined amplitude, a pre-determined frequency, a pre-determined delay, and/or a pre-determined phase.

The calibration means may comprise a feed point, feed connection, or feed pad, which may be provided on the common antenna substrate. The common calibration signal may be input to said calibration means via said feed connection/point/pad.

The feed connection (e.g. the pad) may be connected to each coupler by a respective calibration path each calibration path may be substantially the same length as each other calibration/path.

The calibration means may comprise a substantially planar calibration network provided on a common antenna substrate.

The or each said coupler may be arranged for weak coupling to its respective antenna element.

The calibration means may comprise a hierarchy of calibration branches extending from the feed connection to each coupler. The hierarchy of calibration branches may be fractal in nature. The hierarchy of calibration branches may comprise a plurality of levels each level comprising at least one branch. Each branch at one (e.g. lower) level of the hierarchy (e.g. nearer the calibrator feed) may feed at least two branches at an adjacent (e.g. higher) level of the calibrator hierarchy (e.g. nearer the coupler).

Accordingly, the calibrator network may comprise a 2×2×2 . . . branch scaling sequence between lower levels of the calibrator hierarchy (nearer the calibrator feed) and higher levels (nearer the couplers).

### Multiple Substrate

The at least one antenna may comprise a plurality of sub-arrays that each may comprise a plurality of antenna elements. Each sub-array may be provided on a different respective substrate. Each sub-array may be substantially co-planar.

### Other Features

The first processing stage may comprise comprises at least one of: (a) an Radio Frequency (RF) stage for carrying out RF processing for said radar signals; (b) an Intermediate Frequency (IF) stage for carrying out down-conversion to an IF, and/or other IF processing functions, for processing said radar signals; and (c) an Analogue to Digital Conversion (ADC) stage for carrying out analogue to digital conversion for processing said radar signals.

The first and second processing stages may be adjacent stages in a processing hierarchy or may be separated by one or more other processing stages.

The second processing stage comprises at least one of: (a) an Intermediate Frequency (IF) stage for carrying out down-conversion to an IF, and/or other IF processing functions, for processing said radar signals; and (b) an Analogue to Digital Conversion (ADC) stage for carrying out analogue to digital conversion for processing said radar signals; and (c) a timing control stage for providing control and/or timing signals for processing said radar signals.

The first processing stage may comprise an input stage (e.g. the RF stage) preferably adapted to process signals as received by the antenna elements to produce associated output signals. The first processing stage may comprise an intermediate stage (e.g. the IF stage or the ADC stage) preferably adapted to process output signals from a further processing stage (e.g. the RF stage or the IF stage) to process said radar signals received via each antenna element of said array.

The second processing stage, for example: may be a processing stage (e.g. a timing control stage, or an analogue to digital conversion stage) which serves the first processing stage by providing signals (e.g. control or timing signals) to the first processing stage for use in processing the radar signals; and/or may be a processing stage (e.g. an IF stage or an analogue to digital conversion (ADC) stage) which serves the first processing stage by processing output signals produced by the first processing stage.

The radar receiver may comprise a further processing stage between the first and second processing stages which may be arranged substantially parallel to the other or each other processing stages and/or to the antenna.

The further processing stage, for example: may be a processing stage (e.g. an ADC stage) which serves the first processing stage by providing signals (e.g. control or timing signals) to the first processing stage for use in processing the radar signals; and/or may be a processing stage (e.g. an IF stage or an ADC stage) which serves the first processing stage by processing output signals produced by the first processing stage. The second processing stage, in this case may be a processing stage (e.g. a timing control stage, or an analogue to digital conversion stage) which serves the further and/or the first processing stage by providing signals (e.g. control or timing signals) to them; and/or may be a processing stage (e.g. an ADC stage) which serves the first and/or further processing stage by processing output signals produced by them (directly or indirectly).

The receiver may be provided with receiver circuitry (which may comprise the processing stages) in a layered architecture, each layer comprising an associated processing stage for processing the signals received via the elements of the receiver array.

Each processing stage may be substantially planar, and may comprise one or more circuit cards, with the associated circuitry preferably extending substantially parallel to, but spaced from, the face of the receiver antenna (or antenna elements thereof) and preferably extending substantially parallel to, but spaced from, the circuitry of each of the other processing stages.

The processing stages may be arranged such that the substrate (or plurality of substrates) on which the stage is fabricated (possibly with metallic support components), can act effectively as a shield to interference (e.g. electro-magnetic interference) from other stages.

The circuitry of each processing stage may be modular. The processing stages may, for example, have a plurality of functionally similar (or identical) circuit modules (or sub-modules) each of which may be arranged to carry out processing and/or control functions for a group (e.g. a sub-set or sub-array) of antenna elements.

The circuitry may be arranged in a modular hierarchy possibly with a processing stage at one level of the hierarchy having the same number (preferably a greater number than) of modules (or preferably a greater number of modules than) a processing stage at a lower level of the hierarchy. Each circuit module of a processing stage at a lower level of the hierarchy may be operable to process output signals from (or provide control/timing signals to) one or more circuit modules at a higher level of the hierarchy.

The modular hierarchy may be arranged such that electrical signal paths through the hierarchy are inherently symmetrical, and may be such that each signal path has substantially the same transmission path characteristics (for example, path length). Radar signals received at the respective antenna elements are preferably handled and controlled in substantially the same manner.

The circuitry/processing stages may be housed in a housing or other such enclosure, which may comprise a support structure is such that each module of a particular processing stage may be located in its own respective structural recess, space, cavity or void. The perimeter of the recess, space, cavity, or void may act as a screen (e.g an electromagnetic screen), for example to interference from functionally equivalent modules in neighbouring recesses, spaces, cavities or voids. Each module may be rigidly interconnected with one or more other similar modules using said support structure.

The centre of a circuit module (e.g. the timing control module or ADC module) may be aligned with the centre of an array (e.g. 1×2, 2×2, or larger array) of circuit modules (e.g. ADC, IF, or RF modules) or antenna elements which it serves.

The radar receiver may be operable anywhere in the L-Band (e.g. 1 GHz to 2 GHz), S-Band range (e.g. 2 GHz-4 GHz) to the C-Band range (e.g. 4 GHz to 8 GHz), or possibly beyond (on either side).

The array may comprise an integer multiple of 2. The array may comprise m elements, where m is a multiple of 2, a multiple of 4, a power of 2, and/or a power of 4 m may, for example, be 4, 8, 16, 64, 256 or more. The array may be numerically square or numerically rectangular.

### Other Aspects

According to another aspect of the invention there is provided a radar receiver, the receiver comprising: at least one antenna comprising an array of antenna elements arranged in a plurality of sub-arrays, wherein each sub-array comprises a plurality of antenna elements; a first processing stage adapted to process radar signals received via each antenna element of said array; and a second processing stage adapted to serve the first processing stage; wherein said first and second processing stages are each arranged substantially parallel to one another, and to said antenna substrate; wherein the first processing stage comprises a plurality of processing modules, each processing module being adapted to process radar signals received by a different said sub-array of antenna elements.

The second processing stage may comprise at least one processing module, the or each processing module being adapted to serve a plurality of said processing modules of the first processing stage.

According to another aspect of the invention there is provided a radar receiver, the receiver comprising: at least one antenna comprising an array of antenna elements; a first processing stage adapted to process radar signals received via each antenna element of said array; and a second processing stage adapted to serve the first processing stage; wherein said first and second processing stages are each arranged substantially parallel to one another, and to said antenna substrate; and wherein the first and/or second processing stage is provided on a substrate that is adapted to provide shielding from interference.

Each said processing stage may be fabricated on a circuit board arranged for screening each said processing stage from said interference.

According to another aspect of the invention there is provided a radar receiver, the receiver comprising: at least one antenna comprising an array of antenna elements; a first processing stage comprising a plurality of processing modules adapted to process radar signals received via the antenna; and a second processing stage comprising at least one processing module that is adapted to serve at least one, preferably a plurality, of said processing modules of the first processing stage; wherein said first and second processing stages are each arranged substantially parallel to one another, and to said antenna substrate; and wherein each module of the first processing stage and/or each module of said second processing stage is provided with means for screening the or each said module from interference.

The interference may, for example, be electromagnetic interference

According to another aspect of the invention there is provided a radar receiver, the receiver comprising: at least one antenna comprising a plurality of antenna elements arranged on a common antenna substrate; and means for providing a common calibration signal to each said antenna element; wherein said calibration means comprises a plurality of couplers provided on said common substrate (or in the first processing stage), and wherein each coupler is arranged for coupling to a respective antenna element whereby to provide said calibration signal.

According to another aspect of the invention there is provided a radar receiver, the receiver comprising: at least one antenna comprising a plurality of antenna elements arranged on a common substrate; and a processing stage, parallel to said common substrate, adapted to process radar signals received via each antenna element; means for providing a common calibration signal to each said antenna element; wherein said calibration means comprises a plurality of couplers provided in said parallel processing stage, and wherein each said coupler is arranged to couple with a connection to a processing element associated with each respective antenna element.

The calibration means may comprise a calibration network. The calibration means may be used for measurement of a phase and/or amplitude response of an antenna element.

The calibration network may extend between the antenna elements on the face of the antenna. The calibration network may be such that the network comprises equal-length paths. The calibration network may comprise a single feed point (e.g. a feed connection or feed pad). During calibration signals may be introduced via the feed-point.

The calibration coupler may be arranged to allowed a weak coupling (e.g. a weak electro-magnetic coupling) between the coupler and a respective antenna element.

In operation to calibrate (or recalibrate) the antenna the calibration network may be fed with a low-level signal. The low-level signal may be from an RF source which may be synchronised with the radar, receiver. The low-level signal may be coupled weakly into each antenna element, for example, via a respective calibration coupler.

The response of each channel may be adjusted numerically, for example by a signal processor. Calibration may be absolute, for example assuming the various transmission branches have identical signal propagation characteristics. Calibration may be made by reference to a base calibration. The base calibration may, for example, characterise the calibration network, for example, differences between the branches of the network which may then be taken into account in subsequent recalibrations. The base calibration may be provided, for example, by use of an external plane-wave source at manufacture, or during a recalibration procedure.

According to another aspect of the invention there is provided a radar receiver, the receiver comprising: at least one antenna comprising a substantially planar array of antenna elements arranged in a plurality of sub-arrays that each comprise a plurality of antenna elements; wherein each said sub-array is provided on a different respective substrate.

Each sub-array may have an equal number of elements and/or may comprise n elements where n is a multiple of 2, a multiple of 4, a power of 2, and/or a power of 4 n may, for example, be 4, 8, 16 or 64.

### Operation Method

According to another aspect of the invention there is provided a method of operating a radar receiver, the method comprising: receiving radar signals via an array of antenna elements forming at least one antenna; processing said radar signals using a first processing stage; and processing said radar signals using a second processing stage that is adapted to serve the first processing stage; wherein said first and second processing stages are each arranged substantially parallel to one another, and to said antenna substrate.

Processing said radar signals using a second processing stage may comprise using a timing and/or control signal provided by the processing stage to process the radar signals.

### Fabrication Method

According to another aspect of the invention there is provided a method of forming a radar receiver, the method comprising: providing at least one antenna comprising an array of antenna elements; providing a first processing stage adapted to process radar signals received via each antenna element of said array; and providing a second processing stage adapted to serve the first processing stage; arranging said first and second processing stages substantially parallel to one another, and to said antenna substrate; interconnecting said antenna and said first and second processing stages to form said radar receiver.

Said providing steps and/or said interconnecting step may be such as to form a radar receiver according to any of the radar receiver aspects.

### Calibration Method

According to another aspect of the invention there is provided a method of calibrating a radar receiver, wherein: the radar receiver comprises: at least one antenna comprising a plurality of antenna elements arranged on at least one substrate; and means for providing a common calibration signal to each said antenna element; wherein said calibration means comprises a plurality of couplers provided on said substrate, and wherein each coupler is arranged for coupling to a respective antenna element whereby to provide said calibration signal; and the method comprises: inputting said common calibration signal to said calibration means; measuring a response of at least one of said antenna elements; and calibrating said radar receiver in dependence on said response of the at least one of said antenna elements.

According to another aspect of the invention there is provided a method of calibrating a radar receiver, wherein: the radar receiver comprises: at least one antenna comprising a plurality of antenna elements arranged on a common substrate; a processing stage, parallel to said common substrate, adapted to process radar signals received via each antenna element; and means for providing a common calibration signal to each said antenna element, wherein said calibration means comprises a plurality of couplers provided in said parallel processing stage, each said coupler being arranged to couple with a connection to a processing element associated with each respective antenna element; and the method comprises: inputting said common calibration signal to said calibration means; measuring a response of at least one of said processing elements; and calibrating said radar receiver in dependence on said response of the at least one of said processing elements.

Calibration may comprise digital correction of a phase and/or amplitude response of an antenna element.

It will appreciated that where the specification refers to the processing of radar signals, the processing may comprise the direct processing of signals as received by the antenna elements; and/or indirect (e.g. intermediate) processing of radar signals as converted into analogue and/or digital electrical signals in processing circuitry and/or processing software (e.g. digital signal processing) on a general purpose of specialist computer.

Where the specification refers to one processing stage/module serving another processing stage/module and/or serving a plurality of antenna elements this may comprise: providing signals (e.g. control or timing signals) for use in the processing of said radar signals by the served processing stage/module and/or received by the served antenna elements; processing output/radar signals from the served processing stage/module/antenna elements.

The invention will now be described by way of example only with reference to the attached figures in which:

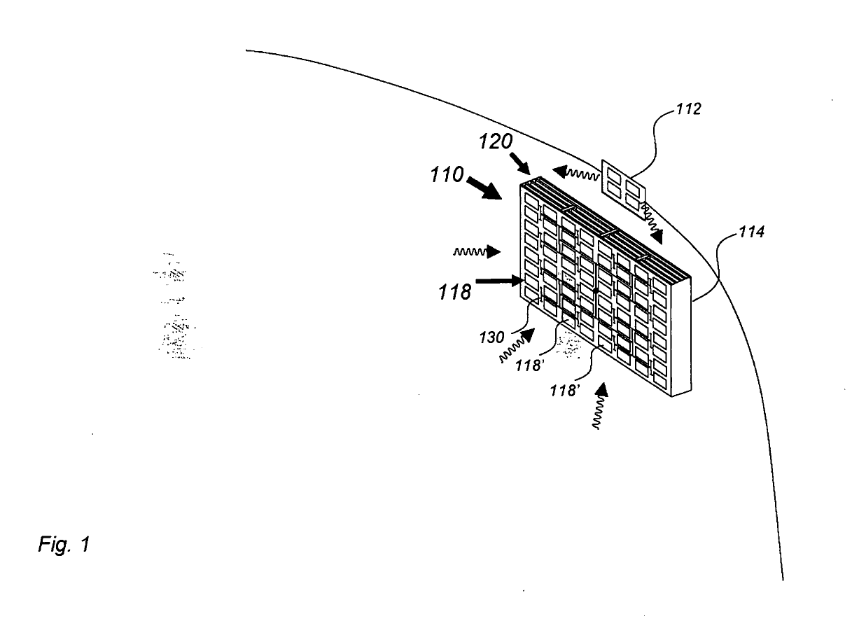

FIG. 1 shows in overview a radar system incorporating a radar receiver according to an exemplary embodiment of the invention;

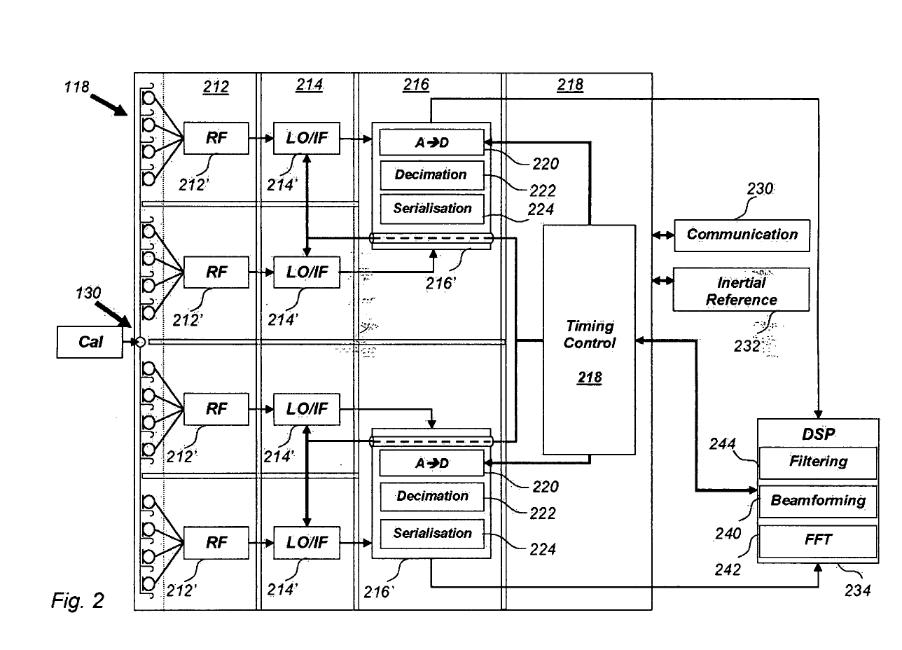

FIG. 2 shows a simplified block schematic of a radar receiver according to an exemplary embodiment of the invention;

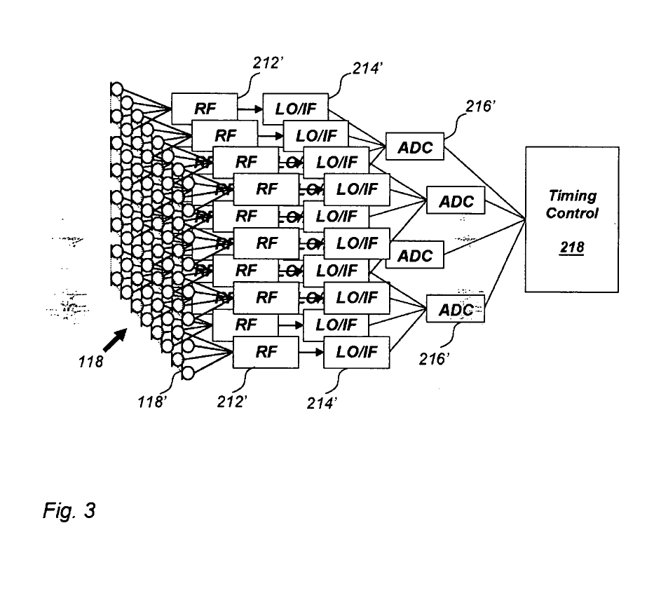

FIG. 3 shows another simplified schematic illustrating the hierarchical nature of the radar receiver of FIG. 2;

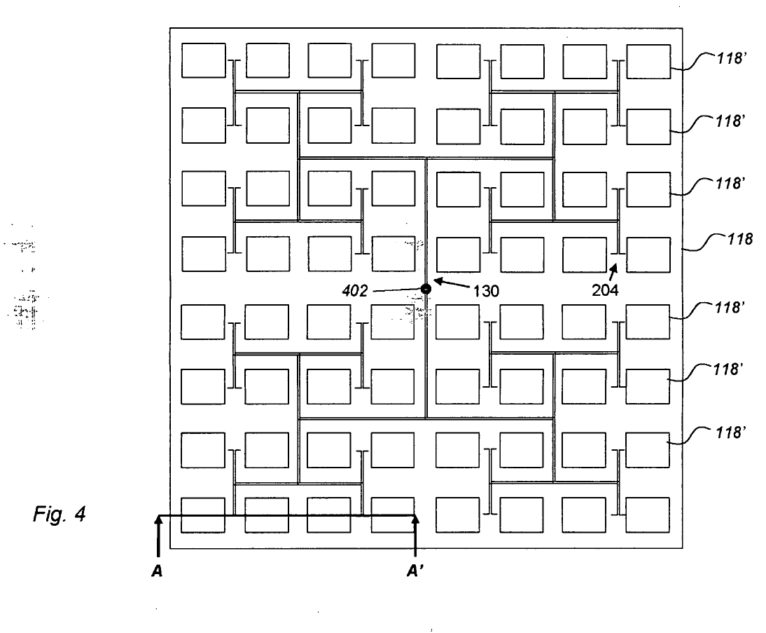

FIG. 4 shows a simplified plan-view of the radar receiver of FIG. 2;

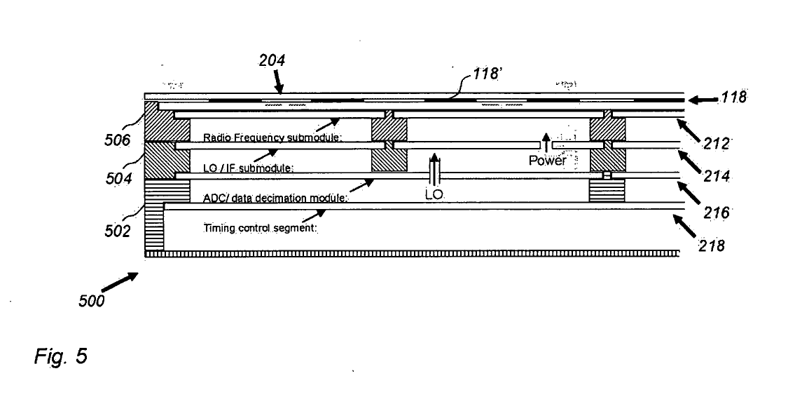

FIG. 5 shows a simplified cross-section of the radar receiver of FIG. 2;

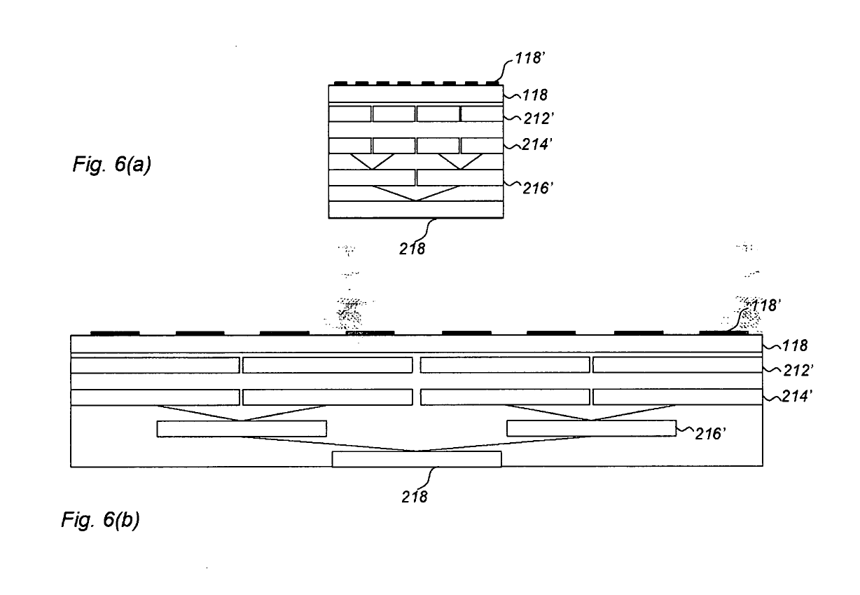

FIGS. 6(a) and 6(b) show comparative illustrative views of the layer structure of two further;

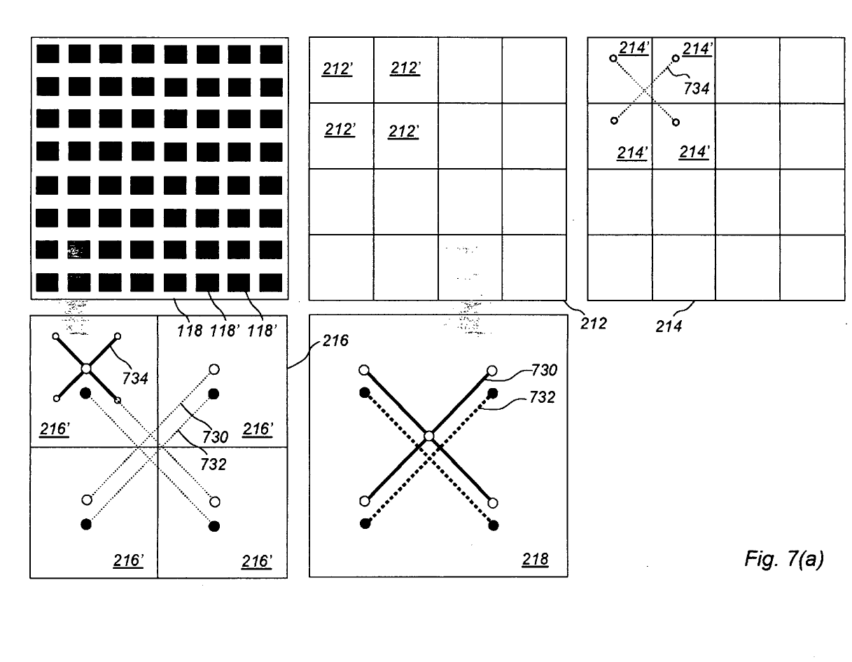

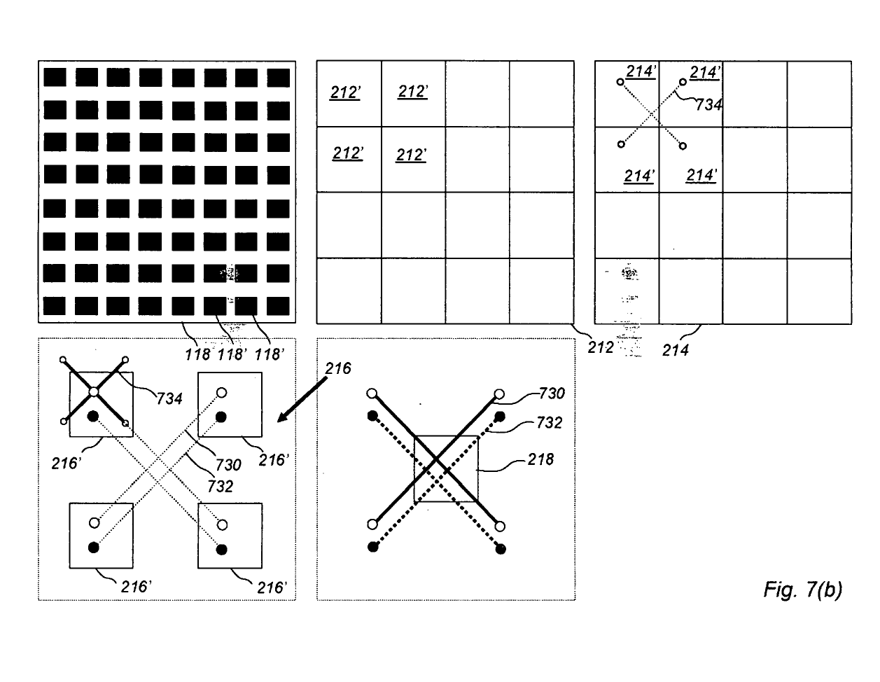

FIGS. 7(a) and 7(b) illustrates the relative size of circuit footprints for different processing stages of the radar receivers according to FIGS. 6(a) and 6(b);

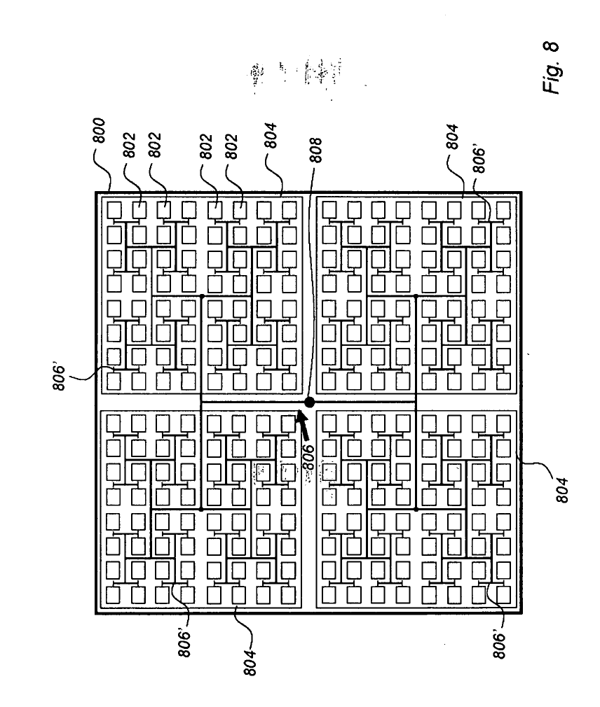

FIG. 8 illustrates a yet further exemplary receiver; and

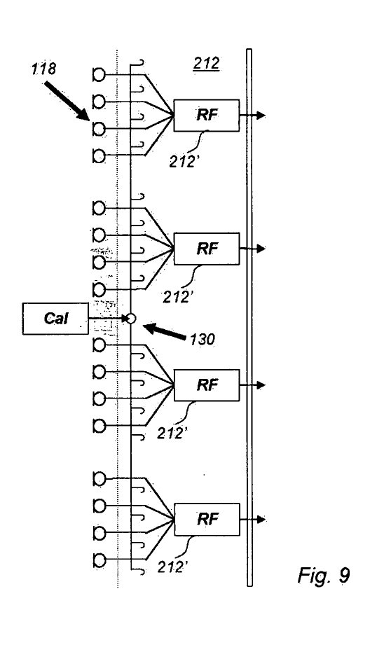

FIG. 9 shows a simplified (and partial) block schematic of a radar receiver according to another exemplary embodiment of the invention.

### Overview

In FIG. 1 an exemplary radar system is shown generally at 110. The radar system 110 of this example comprises a ‘holographic’ radar system comprising a transmitter 112 for illuminating a volume of interest with radar signals and a receiver 114 for receiving and processing return signals reflected from within the illuminated volume. In this example the radar system 110 is implemented on a moving platform such as a marine vessel (not shown).

The transmitter 112 is adapted to illuminate a broad field of view (generally representing an entire volume of interest) by means of a wide angle transmitter beam, rather than illuminating a smaller volume (e.g. representing a subdivision of a volume of interest) using a narrower beam. The receiver 114 is adapted to allow the broad field of view to be subdivided into smaller regions of interest, at the reception side, by use of accurate phase/delay control to effectively form beams for reception, and/or range gating to form reception range swathes.

The transmitter 112 is provided with a transmitter antenna comprising an array of transmitter antenna elements via which the transmitter 112 illuminates the whole volume of interest with a coherent signal modulated appropriately (for example as a regular sequence of pulses) to permit range resolution.

The receiver 114 is provided with a receiver antenna 118 comprising a substantially planar array of receiver antenna elements 118′. Each element 118′ of the receiver array is capable of receiving signals returned from substantially the whole of the illuminated volume of interest. In this embodiment, the receiver antenna 118 comprises 64 antenna elements arranged in an 8×8 array on a single substrate. It will be appreciated, however, that any suitable array dimensions and number of elements may be used.

### Layered Structure

The receiver 114 is further provided with receiver circuitry 120 in a layered architecture, each layer comprising an associated processing stage for processing the signals received via the elements of the receiver array. As will be described in more detail below, the receiver circuitry 120 includes processing stages for providing analogue receiver functions such as radio frequency (RF) amplification, filtering, gain control, intermediate-frequency (IF) down conversion, etc. The receiver circuitry 120 also includes processing stages for providing other processing and control functions such as analogue to digital conversion, decimation, serialisation, etc., and functions such as timing control.

As shown, for example in FIG. 5, in this embodiment, each processing stage is substantially planar, and comprises one or more circuit cards, with the associated circuitry extending substantially parallel to, but spaced from, the face of the receiver antenna 118 and the circuitry of each of the other processing stages. The processing stages are arranged such that the substrate (or plurality of substrates) on which the stage is fabricated, together with metallic support components, can act effectively as an electro-magnetic shield to interference from other stages. This is of particular benefit in the case of the processing stage which is responsible for handling radio frequency (RF) processing and the processing stage which is responsible for handling intermediate-frequency (IF) down-conversion and processing.

### Hierarchical Modular Architecture

The circuitry of each processing stage is modular, with most of the processing stages having a plurality of functionality similar or identical circuit modules (or sub-modules) arranged to carry out processing and/or control functions for a sub-set (or sub-array) of antenna elements 118′. The circuitry 120 is also arranged in a modular hierarchy with a processing stage at one level of the hierarchy having either the same number, or a greater number, of modules than a processing stage at a lower (further from the face of the receiver antenna 118) level. Each circuit module of a processing stage at a lower level of the hierarchy is thus operable to process output signals from (or provide control signals to) one or more circuit modules at a higher level of the hierarchy (e.g. closer to the antenna).

As will be described in more detail below, the modular hierarchy is arranged such that electrical signal paths through the hierarchy are inherently symmetrical, thereby ensuring that each signal path has substantially the same transmission path characteristics (in particular, path length) and, accordingly, that radar signals received at the respective antenna elements are handled and controlled in substantially the same manner.

The support structure of the enclosure in which the circuitry 120 is housed is constructed such that each module of a particular processing stage is located in its own respective structural void, the perimeter of which acts as an electromagnetic screen, for example to interference from functionally equivalent modules in neighbouring voids. Thus, each module can be manufactured in an inexpensive manufacturing process as a robust lightweight unit, which can then be rigidly interconnected with other similar modules in a relatively simple assembly process, to form the layered architecture described above.

### Calibration Network

The receiver 114 is also provided with a calibration network 130 (described in more detail below) that can be used to improve the performance of the receiver 114 by the measurement and then digital correction of the phase and amplitude response of each antenna element, so that the required beams can be formed accurately. The calibration network 130 extends between the antenna elements on the face of the antenna such that the network 130 is accessible by equal-length paths, thereby allowing known calibration signals to be introduced into the network from a single feed point, and hence measurement and correction to be repeated, so that the calibration can be updated at any time.

### Benefits

Accordingly, both the processing stages and the individual modules are maintained in isolation by using the enclosure and the circuit cards themselves as effective barriers to crosstalk. The primary signal processing functions are each carried out in screened enclosures provided by the circuit cards and the support structure. Furthermore, the electrical signals propagating through the circuit only travel perpendicular to the array as they pass from layer to layer of the process. Thus, this arrangement provides beneficial isolation of each layer of the process from each other layer.

In particular, the use of this layered structure, with a modular architecture, has a number of advantages over alternative ‘orthogonal’ structures in which the circuitry for each antenna element is fabricated on large, closely packed, multi-function, circuit cards which extend perpendicularly back from the plane of the antenna face.

In an orthogonal arrangement, for example, the electrical signals propagating through the various stages of processing for each channel generally travel in planes at right angles to the face of the antenna elements. Accordingly, whilst an orthogonal structure theoretically allows the potentially substantial receiver circuitry to be located behind each antenna element (which may occupy only a small area in the antenna face), without appropriate screening such an arrangement provides a significant risk of interference between signals at different stages of the process—most particularly involving the Local Oscillator (LO) or high-speed serial digital signals interfering with the antenna or Radio Frequency (RF) circuits. However, in such orthogonal structures screening is generally expensive requiring individual structurally complex screening enclosures for each channel.

The layered structure described, however; can potentially be manufactured at relatively little expense whilst providing the potential for inherent layer-layer ‘self-screening’. Furthermore the use of the modular architecture with the support structure configuration described provides for even greater manufacturing simplicity, whilst maintaining a generally stable mechanical configuration in which layer to layer and module to module interference are minimised, resulting in associated benefits in terms of receiver performance and in particular parasitic channel to channel variation.

The hierarchical symmetry and modular nature of the architecture also provides inherent benefits in terms of scalability, for example, between C-band receivers (˜4 GHz to ˜8 GHz) having relatively small, densely spaced, array elements and associated RF, IF and ADC circuit modules, and L-band receivers (˜1 GHz to ˜2 GHz) having a distinctly larger, more spread out, array elements and circuit modules. In particular, the same architecture can be used despite the different functional circuit modules scaling at different rates relative to the wavelength of the radar signals that the receiver 114 is designed to receive and process (for example, the RF and IF modules scale approximately directly with receiver antenna area, especially where printed filter or delay elements are to be used, whilst the size of the timing control circuitry remains approximately constant).

The symmetry of the hierarchical modular architecture is particularly beneficial in supporting the maintenance of accurate timing relationships between the various antenna elements 118′, regardless of the band in which the receiver 114 is designed to operate and the relative sizes of the different circuit modules.

### Receiver in More Detail

FIGS. 2 to 5 illustrate an exemplary embodiment of the radar receiver 114 forming part of the radar system 110 of FIG. 1 in more detail. FIG. 2 is a simplified schematic of the radar receiver 114, FIG. 3 is a simplified block schematic illustrating the hierarchical modular symmetry of the radar receiver 114, FIG. 4 is a simplified plan view of the radar receiver 114, and FIG. 5 is a simplified cross-section approximately through section A→A′ of FIG. 4.

### Circuit Architecture

Referring firstly to FIG. 2, as described above the receiver comprises a plurality of processing stages 212, 214, 216, 218 for processing signals received by the antenna elements 118′ (only 16 of which are shown). The processing stages 212, 214, 216, 218 include a radio frequency (RF) stage 212, an intermediate-frequency (IF) stage 214, an analogue-to-digital conversion (ADC)/decimation stage 216, and a timing control stage 218.

The radio frequency (RF) stage 212 handles RF functions such as RF amplification of received radar signals or the like. The intermediate-frequency (IF) stage 214 handles IF functions such as mixing of the RF signals with a local oscillator (LO) signal for IF down-conversion, IF amplification, and IF filtering etc. The ADC/decimation stage 216 comprises an ADC block 220 for converting the analogue signal output from the IF stage 214 into digital signals, a decimation block and a serialisation block 224. In operation, the decimation block 222 decimates the samples represented by the converted signals to reduce their number to more computationally manageable levels, whilst the serialisation block 224 converts the inherently parallel converted signals into serial signals for output to subsequent processing stages.

As shown in FIG. 2, each antenna element 118′ has an associated calibration coupler 204 which forms part of the above-mentioned calibration network 130. The calibration coupler 204 is arranged to provide weak electro-magnetic coupling between the coupler 204 and its respective antenna element 118′. Thus, in operation to calibrate (or recalibrate) the antenna the calibration network 130 can be fed with a low-level signal from a single RF source 228 which is synchronised with the radar receiver 114. In this way the low-level signal is coupled weakly into each antenna element via its respective calibration coupler 204. A known signal can therefore be introduced to each antenna channel without impairing or significantly modifying the amplitude and/or phase response of the associated antenna element to incident external electromagnetic waves.

Accordingly, in operation, to calibrate or recalibrate the receiver, all channels are fed with an RF signal at a known amplitude and delay. The response of each channel is then adjusted numerically by the signal processor. Calibration may be absolute, for example assuming the various transmission branches have identical signal propagation characteristics, or may be made by reference to a base calibration which effectively characterises the transmission network thereby allowing differences between the branches of the network 130 to be taken into account in subsequent recalibrations. The base calibration may be provided, for example, by use of an external plane-wave source at manufacture, or during a recalibration procedure.

The use of a weak coupling arrangement (as opposed to an efficient coupling mechanism) is particularly useful as it allows the calibration network to be fabricated on the surface of the antenna, substantially in the same plane as the antenna elements, whilst ensuring that the calibration signal fed into the network does not cause a significant disturbance to each element which might, for example, link it to one or another of its neighbours.

The radar receiver 114 is further provided with a plurality of external sub-systems for providing other functions, including: a communication sub-system 230 for providing communication, for example, between the radar system 112 and a base station (not shown) and/or other radar systems in the vicinity; an inertial reference sub-system 232 for keeping track of movement of the vessel on which the radar is implemented; and a digital signal processing (DSP) sub-system 234 for carrying out target detection, tracking, and analysis (e.g. range, range rate, classification etc.), clutter reduction and the like. The DSP subsystem comprises processing sub-modules for carrying out typical tasks including, for example, sub-modules for receiver beamforming 240, time to frequency transformation 242, and signal filtering 244.

### Modular Hierarchy

As shown in FIG. 2 the RF stage 212 comprises a plurality of RF circuit modules 212′ (four of which are shown). Each RF module 212′ is adapted to carry out RF processing on the signals received from four antenna elements 118′. The IF stage 214 comprises a plurality of IF circuit modules 214′, each being interconnected with a respective RF module 212′. Each IF module 214′ is adapted to carry out LO mixing for IF down-conversion on the output signals from its respective RF circuit module 212′. The ADC/decimation stage 216 comprises a plurality of ADC/decimation circuit modules 216′ (only two of which are shown). Each ADC/decimation circuit module 216′ is adapted to carry out ADC processing, serialisation, and decimation on the outputs of a respective plurality of IF modules 214′.

Each functionally equivalent module of each processing stage 212, 214, 216, 218 is provided in the same plane, substantially parallel to the antenna area.

The timing control stage 218 comprises just a single circuit module which is adapted to provide ADC timing control signals for all the ADC/decimation modules 216′, and LO signals for all the IF modules 214′. As shown in FIG. 2, however, the modular hierarchy is arranged such that the LO signals are propagated up through the processing layers to the IF modules 214′ of the IF stage 214, via their respective ADC/decimation module 216′. Accordingly, the timing control layer serves all the antenna elements 118′, and the propagation paths for the timing and local oscillator signals are inherently symmetrical and hence can be easily fabricated to be the same or substantially the same length.

In FIG. 2 only a sub-set (16) of the 64 antenna elements and their associated circuit modules are shown to aid clarity. For completeness, however, FIG. 3 illustrates, in schematic form, the modular hierarchy for the entire 64 element (8×8) array of this embodiment. As FIG. 3 illustrates, there are 16 RF modules 212′ each serving four antenna elements arranged in a 2×2 array. There are also 16 IF modules 214′, each serving a single RF module 212′ and, accordingly, the 2×2 array of antenna elements. As mentioned above, there is only a single timing control module 218 serving all four ADC/decimation modules 216′, 16 IF modules 214′, 16 RF modules 212′ and, hence, all 64 antenna elements.

As will be appreciated, the use of multiples of four between different levels of the modular hierarchy is particularly advantageous because of the inherent symmetry involved when used with a square or rectangular array of antenna elements. Specifically, by simply aligning the centre of a lower level circuit module (e.g. the timing control module 218′) with the centre of the 2×2 array of circuit modules (e.g. the ADC/decimation modules 216′) lower level circuit module serves, helps to ensure that the signal paths for each antenna element in the square or rectangular array, through each layer of the receiver circuitry, is substantially the same, and indeed minimised.

### Physical Structure

FIGS. 4 and 5 illustrate the physical structure of the receiver 114.

As shown in FIG. 4, the structure of the calibration network 130 comprises a network of transmission lines which are arranged to extend symmetrically between the elements 118′ of the antenna array in branches of substantially equal length. A calibrator feed 402 is provided at the centre of the network via which the known signal may be introduced as described above. Thus, the delay associated with each branch of the network is nominally the same, and is very stable since only resistive and transmission-line components are used. A high degree of attenuation can thus be permitted between the source and each antenna.

As seen in FIG. 4, the calibration network extends from the calibrator feed 402 (which is at the centre of the array) in a generally fractal manner in which each branch of the network is at least an approximate reduced-size copy of the whole network, and the preceding branch. More specifically, the main branch of the network extends from the calibrator feed 402, in opposite directions, substantially at the centre of the array of antenna elements (e.g. 4 elements on each side). The main branch extends a distance equal to about one quarter of the array (e.g. two full elements) before splitting, at either end, into two secondary branches. Each pair of secondary branches then extend, in opposite directions substantially perpendicular to the main branch, at approximately one quarter distance (e.g. two full elements) from respective array edges (e.g. from upper and lower edges as seen in FIG. 4). Each secondary branch extends a distance equal to about one quarter of the array (e.g. two full elements) before splitting into a pair of tertiary branches which themselves extend in opposite directions substantially perpendicular to their respective secondary branch. The tertiary branches themselves split into quaternary (and then further) orthogonal branches. In all the 8×8 array comprises five levels of branching (or six if the calibrator itself is included) each branch being a smaller representation of the branch of the previous level.

Accordingly, the calibrator branches are also hierarchical in nature each branch adapted to serve (e.g. by providing the calibrator signal to) two further branches further up the calibrator hierarchy. This ‘2×2×2 . . . ’ hierarchy is particularly beneficial for providing the calibration signal to each antenna element of the 8×8 (numerically square array) using substantially equal path lengths.

The layered structure introduced above can be seen in more detail in the partial cross-section of FIG. 5 which illustrates the parallel orientation of each processing stage 212, 214, 216, 218 relative to the array of antenna elements 118′. Each functionally equivalent circuit module of each processing stage comprises a printed wiring assembly fabricated on a separate substrate (e.g. a printed circuit board or the like) to form a discrete circuit card, and assembled into a substantially co-planar arrangement to form each processing stage 212, 214, 216,218.

The processing stages are rigidly assembled into the layered structure in an enclosure 500. The enclosure 500 comprises a plurality of discrete levels 502, 504, 506 which allow the layered and modular receiver structure to be built up, and rigidly fixed to one another, in layers during progressive stages of an assembly process. Each enclosure level 502, 504, 506 is arranged to provide: a screening perimeter for each circuit module below it (as seen in FIG. 5); a support structure for the circuit modules of the processing stage 212, 214, 216 above it (and/or for the antenna array itself); appropriate spacing of the processing stages 212, 214, 216, 218 from one another; and means by which the individual circuit modules can be held rigidly in place (e.g. by sandwiching between adjacent enclosure levels 502, 504, 506).

Accordingly, each circuit module is located in its own respective structural void, the perimeter of which acts as a screen to electro-magnetic interference from functionally equivalent modules in neighbouring voids. The circuit boards on which the circuit modules are fabricated act as a screen to electro-magnetic interference between circuit modules of processing stages 212, 214, 216, 218 at adjacent levels of the modular hierarchy.

Any suitable assembly and manufacturing techniques and materials can be used to construct the receiver. Typically, however, the enclosure will comprise a lightweight material having the desired screening properties (e.g. aluminium) which is machined to form the enclosure structure.

### Scalability and Uniformity

FIGS. 6(a) to 7(b) illustrate (the benefits in terms of scalability and signal path uniformity that embodiments of the invention can provide by comparison of two exemplary radar receiver embodiments. FIGS. 6(a) and 7(a) respectively illustrate the approximate layer arrangement and approximate relative circuit footprints that may be expected for a C-band radar (somewhere in the approximate range 4 GHz to 8 GHz, e.g. 5 GHz). FIGS. 6(b) and 7(b) respectively illustrate the approximate layer arrangement and approximate relative circuit footprints that may be expected for an L-band radar (somewhere in the approximate range 1 GHz to 2 GHz, e.g. 1.25 GHz). It will be appreciated that the drawings of FIGS. 6(a) to 7(b) are purely illustrative and, in particular, are not to scale.

Subject to the requirements for sensitivity and resolution the size of the antenna array is preferably kept to a minimum. Generally, in this minimum case, the spacing between the elements may be in the order of one or no more than a few half-wavelengths. For example, at an operating frequency of 6 GHz, spacings may be a few centimetres, say between 1 and 10 cm, preferably between 2 and 8 cm. Accordingly, in the higher frequency (G-Band) radar receiver the physical size of the antenna array is much smaller than that of the lower frequency (L-Band) radar receiver because of the shorter wavelength associated with the higher frequency. As illustrated by comparison of the two different radars represented in FIGS. 6(a) to 7(b), the circuitry associated with the RF and IF stages 212, 214 scales approximately in a one-to-one relationship a with the size of the receiver arrays and accordingly the relative circuit footprint of the RF and IF modules 212′, 214′ compared to the physical array sizes is approximately the same for the different frequency receivers.

In the case of the ADC/decimation stage 216, however, circuitry does not scale in a one to one relationship with the antenna size although the size of the ADC/decimation circuit required is, nevertheless, greater at lower frequencies. Accordingly, in the illustrative high frequency example the circuit footprint of the ADC/decimation modules 216′ is approximately equal to the circuit footprint of four RF or IF modules 212′, 214′. Thus, the four ADC/decimation modules 216′ extend substantially across the entire array. Contrastingly, in the illustrative low frequency example the circuit footprint of each ADC/decimation module 216′ is approximately equal to the circuit footprint of just one RF or IF module 212′, 214′.

The difference between the high frequency and lower frequency examples is even more stark in the case of the timing control stage 218 which does not scale significantly with the size of the antenna array. Accordingly, in the illustrative high frequency example timing control stage 218 extends substantially across the entire array. Contrastingly, in the illustrative low frequency example the timing control stage 218 has approximately the same footprint as just one RF module 212′, IF module 214′, or ADC/decimation module 216′.

In the illustrated examples, the LO signal is provided from the timing control stage 218 to the IF modules 214′ via connectors 730 of substantially identical length from the timing control stage 218 to each of the ADC/decimation modules 216′ and via connectors 734 of substantially identical length from each of the ADC/decimation modules 216″ (only one set of which is shown) to the IF modules 214′. Similarly the ADC timing signal is provided via connectors 732 of substantially identical length from the timing control stage 218 to each of the ADC/decimation modules 216′.

As seen in FIGS. 6(a) to 7(b), because of the symmetrical nature of the modular hierarchy, the same uniform connection arrangement can be provided for the low frequency receiver as for the high frequency radar without extending the circuit boards of the ADC/decimation modules 216′ and/or the timing control stage 218. Accordingly, in the low frequency example, the four ADC/decimation modules 216′ and the timing control stage 218 do not extend across the entire array. Instead, as seen in FIGS. 6(b) and 7(b) the four ADC/decimation modules 216′ and the timing control stage 218 are simply positioned with their centres substantially aligned with the centre of the antenna area they serve. In some cases it may be preferred to extend the ADC/Decimation module to provide extended, rigid interconnections.

The manner in which the hierarchical modular architecture is arranged, therefore, allows the substantially uniform control and timing signal paths to be provided from the timing control stage 218, to the ADC/decimation stage 216 and, where necessary, to the IF stage 214. Furthermore, this uniformity can be provided without requiring complex signal paths and in the case of the larger, lower frequency, example without requiring the timing control stage and the ADC/decimation stage 216 to extend unnecessarily to the edges of the antenna array. In addition to benefits in terms of radar performance, therefore, the modular hierarchy can also provide scalability benefits.

### Multi-Substrate Arrays

FIG. 8 illustrates another embodiment of the invention which further emphasises the benefits of the modular hierarchy and the calibration network.

In FIG. 8 a receiver 800 is shown which has an antenna array comprising 256 antenna elements 802. However, unlike the previous embodiments, the antenna elements are not all fabricated on a common substrate but are, instead, fabricated as four co-planar 64 element (8×8) sub-arrays 804 each of which is fabricated on a separate substrate.

A calibration network 806 is provided for allowing calibration and recalibration of the networks as described previously. However, in this embodiment, the calibration network 806 comprises four sub-networks 806′ each of which is arranged in the manner described for the calibration network 130 of the previous embodiments. The calibration network 806 is provided with a calibration feed 808 substantially at the centre of the 256 element array via which the calibration signal may be fed during calibration or recalibration.

It will be appreciated that the spacing between the sub-arrays in FIG. 8 has been shown relatively wide to allow the calibration network to be seen more clearly. In reality the spacing may be smaller such that the spacing between all the elements of the master antenna array is uniform.

### Other Exemplary Embodiments

In one exemplary embodiment of the invention a radar receiver is adapted to incorporate a number of electronics sub-modules, each of which provides receiver functions such as filtering, gain control, and down-conversion for 2 or more, preferably 4 or 16 or 64 or more receiver antenna elements, while being fed by an array of multiple antenna elements formed on a single substrate. There are hierarchical layers of processing and control, each consisting of modules fed by 2, 4 or 16 or more sub-modules and, providing analogue to digital conversion, decimation, serialisation, etc., or of segments fed by 2, 4 or 16 modules, and providing functions such as timing control, and subsystems providing communications, inertial reference, and signal filtering, beamforming and time to frequency transformation.

Such a structure is similar to that illustrated in FIG. 5, and provides the advantage that each module and sub-module is light and rigidly connected with the others, yielding a stable mechanical configuration that supports the maintenance of accurate timing relationships between the elements.

In this embodiment, the stages of the process are maintained in isolation by using the enclosure and the circuit cards themselves as effective barriers to crosstalk. The sub-modules, modules and segments comprise printed wiring assemblies oriented parallel to the face of the antenna array. In this way the primary signal processing functions are each carried out in screened enclosures provided by the circuit cards and the support structure. The signals only travel perpendicular to the array as they pass from layer to layer of the process. This provides improved isolation of each layer of the process from each other layer, such as: RF gain and filtering, and down-conversion, Intermediate Frequency (IF) functions, and analogue to digital conversion (ADC), data decimation, filtering and serialisation, etc.

As seen in FIG. 5, each segment of the circuit is thus isolated and screened, with the exception of controlled-impedance (coaxial) or low-frequency interconnections between layers.

The single-substrate antenna array of this embodiment is also provided with a calibrator that may be used to improve performance by allowing measurement, and then digital correction of the phase and amplitude response of each antenna element, to ensure that the required beams are formed accurately. This correction can be updated at any time. Thus the calibration network allows initial calibration of the receiver and recalibration at appropriate intervals.

The calibrator comprises a network of transmission lines, fed from a single RF source synchronised with the radar receiver (e.g. as shown in FIG. 4). In this circuit a low-level signal is coupled weakly into each antenna element. This allows a known signal to be introduced without impairing or significantly modifying the amplitude or phase response of each element to incident external electromagnetic waves.

The delay associated with each branch of the network is nominally the same, and is very stable since only resistive and transmission-line components are used. A high degree of attenuation is permitted between the source and each antenna. When activated, the calibrator feeds in a RF signal at a known amplitude and delay to each channel, whose response can then be adjusted numerically by the signal processor. Calibration may be absolute, or may be referred to a known base calibration provided by an external plane-wave source at manufacture or during a recalibration procedure.

Accordingly, in this and other embodiments there is provided a modular radar receiver or array of receivers each provided with a single-substrate array antenna, RF electronics, frequency conversion electronics, IF electronics, A to D conversion and digital processing electronics, in which the electronics circuit modules are arranged with multi-element substrates in planes substantially parallel to the plane of the antenna array, each serving at least 4, 16, 64 or other power of 4 sub-modules, modules, segments or subsystems.

In this and other embodiments a single-substrate, N-element array antenna is provided with a calibrator consisting of a network of transmission lines feeding N parasitic radiating elements coupled loosely to each antenna element which, when excited with a radio frequency signal, provides input to each antenna at a known and stable frequency, phase and amplitude.

In one embodiment a phased array radar receiver is provided in which antenna elements are grouped in multiple square or rectangular sub-arrays of 4, 16, 64 or 256 elements, each sub-array being formed on a single substrate.

### Modifications and Alternatives

Whilst the embodiments described have related to a single substrate antenna array having 64 receiver elements on a single substrate, it will be appreciated that the array may have any suitable number of elements, for example 4, 16, 64, 256 or even more elements, although the modular hierarchy described is of particular benefit in systems comprising a relatively large number of receiver elements.

Furthermore, whilst the architecture described is particularly beneficial for Y x Y arrays (where Y is 2 or a multiple of 4) having antenna elements in powers of 4 (i.e. 4X where X is an appropriate integer—e.g. X=1, 2, 3, 4 or 5), the architecture could easily be adapted for receiver arrays of other sizes and/or shapes whilst still maintaining much benefit. This is especially true for arrays having antenna elements in other powers of 2 (2X—e.g. 2, 8, 32, 128, 512 or more) although other numbers of antenna elements are possible, in particular, multiples of square numbers. The arrays also need not comprise a numerically ‘square’ pattern (e.g. Y×Y) but could be arranged in numerically ‘rectangular’ patterns (e.g. Y×Z in particular where Y and Z are different multiples of 2). It will be appreciated that the terms ‘numerically square’ and ‘numerically rectangular’ are used to distinguish them from the physical shape of the antenna array which, depending on the shape of the antenna elements may be physically square, or rectangular regardless of differences in the number of antenna elements in each row and column.

It will also be appreciated that, whilst the use of multiples of four between different levels of the modular hierarchy is particularly advantageous, different multiples could be used. For example, other advantageous layer-to-layer multiples would be powers of 4 (4X—e.g. 4, 16, or higher multiples) because of the symmetry involved. Similarly, multiples comprising powers of 2 (2X—e.g., 2, 8, 32, 128, 512 or more) or even multiples of 2 (e.g. for 6 antenna elements arranged in a 2×3 array, 12 elements in a 3×4 array, 20 elements in a 4×5 array etc.) would provide some benefit, especially where the modules of the higher level processing stages (e.g. the RF and IF stages) serve antenna sub-arrays comprising two elements.

It will also be appreciated that whilst planar antenna arrays are particularly advantageous for reasons of manufacturability and simplicity, the antenna array could potentially be non-planar, for example, being arranged in a trapezoidal, prismatic, or piecewise approximation at a curved (e.g. concave or convex) surface. In such an arrangement sub-arrays (e.g. 2×2) of the main antenna array could, for example, each be arranged on a separate, single-substrate, surface arranged to face a different direction. Where there is a non-planar array one or more (or all) the processing stages could be arranged with surfaces of their respective modules substantially parallel to the surface of the antenna sub-array they serve, or in a symmetrical arrangement relative to them to ensure uniformity in the control signal paths between lower levels (further from the antenna) of the modular hierarchy and higher levels.

As illustrated in FIG. 9, rather than providing the calibration network on the same ‘common’ substrate as the antenna array, the calibration network may, advantageously, be provided in the RF (or indeed some other) processing stage 212 with the couplers arranged to couple to a connection to a respective processing element (of the processing stage) associated with each antenna element (rather than directly to each antenna element on the antenna substrate itself). For example, as seen in FIG. 9, the coupler may couple to a connection between the antenna element and the processing element 212′. It will be appreciated, however, that the coupler may be arranged to couple to a dedicated processing element (not shown) that is provided to aid calibration, for example, by boosting the calibration feed signal or the like. The arrangement of FIG. 9 has the potential benefit of simplifying the design and fabrication of the antenna substrate and advantageously can allows the calibration network to be updated (e.g. along with modifications to the design of the processing stage in which it is located) without replacing the antenna substrate itself. Other than this, the embodiment of FIG. 9 is substantially the same as described previously.

Providing each module on a separate substrate allows small, lightweight substantially identical modules to be produced in high volumes, at relatively low cost in a high yield manufacturing process. Such an arrangement also has benefits during assembly of the modules into a screening enclosure structure as described above. However, all the modules (or a subset of them) of a particular processing stage could potentially be fabricated on a common substrate where it is beneficial to do so. Each module on the common substrate could then be provided with individual screening during assembly to individually locate it in its own respective screened void in the enclosure structure.

Furthermore, whilst the screened voids in which the circuitry of each module is located could be air filled (thereby, simplifying the manufacturing process), each void could potentially be filled or partially filled with an electro-magnetic radiation suppression filler in the form of a foam, resin, or the like introduced during the assembly process.

Whilst the processing stages and the circuit modules have been described in terms of particular functionality it will be appreciated that they could be provided with other functions. For example, the IF modules, and/or timing control module, may be provided with gain control functionality. Furthermore, the timing control module may be adapted to provide other timing/control signals such as a common timing signal and may be adapted to interact with the external subsystems for example by providing data framing (start stop) signals to the DSP sub-system for time-frequency transformation or the like.

It will be appreciated that although the transmitter is described as comprising an array of transmitter antenna elements, the transmitter may comprise a single transmitting element.

Although the radar system is described in terms of implementation and operation on board a marine vessel it will be appreciated that the radar system may be implemented on any suitable terrestrial, marine, sub-marine or airborne vehicle with suitable adaptation. The radar receiver may also be implemented on a static platform, e.g. for detecting, tracking, and analysing moving targets such as aircraft, cars, people, or the like.

It will be appreciated that embodiments of the radar receiver described herein have many applications including general application in cluttered and highly cluttered environments such as a wind farm, a collection of wind farms, a ship or groups of ships, sea clutter, buildings and other similar major structures, especially ports, docks, marinas or harbours or the like.

Furthermore the receiver has applications as a precision approach radar, maritime radar, air surveillance radar, perimeter monitoring radar etc.

It will be appreciated that the receiver, circuitry, processing stages and/or sub-systems may for example, be in accordance with that described in International Patent Application having publication number WO97/14058 whose disclosure is incorporated by reference.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Statements in this specification of the “objects of the invention” relate to preferred embodiments of the invention, but not necessarily to all embodiments of the invention falling within the claims.

The description of the invention with reference to the drawings is by way of example only.

The text of the abstract filed herewith is repeated here as part of the specification. In an exemplary aspect of the invention there is provided a radar receiver having an antenna. The antenna has an array of antenna elements. The receiver also includes a number of processing stages including a first processing stage adapted to process radar signals received via each antenna element of the array and a second processing stage adapted to serve the first processing stage. The processing stages are each arranged substantially parallel to one another, and to the antenna substrate.

1. A radar receiver, the receiver comprising;
at least one antenna comprising an array of antenna elements;
a first processing stage adapted to process radar signals received via each antenna element of said array; and
a second processing stage adapted to serve the first processing stage;
wherein said first and second processing stages are each arranged substantially parallel to one another, and to said antenna substrate.

2. A radar receiver, according to claim 1 wherein:
said array of antenna elements are arranged in a plurality of groups (e.g. sub-arrays);
said first processing stage comprises a plurality of processing modules, each processing module being adapted to process radar signals received by a different said group of antenna elements of said array; and
said second processing stage comprises at least one processing module, the or each processing module being adapted to serve at least one (preferably a plurality) of said processing modules of the first processing stage.

3. A radar receiver according to claim 1 wherein the radar receiver further comprises means for providing a common calibration signal to each said antenna element; wherein said calibration means comprises a plurality of couplers; and wherein each coupler is arranged for coupling to a respective antenna element whereby to provide said calibration signal.

4. A radar receiver according to claim 1 wherein the at least one antenna is arranged in a plurality of groups, wherein each group comprises a plurality of antenna elements; and wherein the first processing stage comprises a plurality of processing modules, each processing module being adapted to process radar signals received by a different said group of antenna elements.

5. A radar receiver according to claim 4 wherein the second processing stage comprises at least one processing module, the or each processing module being adapted to serve at least one, preferably a plurality, of said processing modules of the first processing stage.

6. A radar receiver according to claim 2 wherein the or each processing module of the second processing stage is adapted to serve a plurality of said processing modules of the first processing stage by providing a timing and/or control signal to each said processing module of the first processing stage.

7. A radar receiver according to claim 6 wherein said timing and/or control signal is provided to each said processing module of the first processing stage via a different respective connection, each said connection having substantially equal path length to each other said connection.

8. A radar receiver according to claim 2 wherein the or each processing module of the second processing stage is positioned substantially centrally relative to said plurality of processing modules which it serves.

9. A radar receiver according to claim 2 wherein the or each module of said second processing stage is adapted to serve N modules of the first processing stage wherein N is an integer power of 2, preferably an integer power of 4, advantageously 4.

10. A radar receiver according to claim 2 wherein the or each module of said first processing stage is adapted to process radar signals received by a group comprising M antenna elements wherein M is an integer power of 2, preferably an integer power of 4, and more preferably 4.

11. A radar receiver according to claim 9 wherein:
(a) the first processing stage comprises at least four first stage processing modules each of which serves at least four antenna elements; and
(b) the second processing stage comprises at least four second stage processing modules each of which serves at least four first stage processing modules and 16 antenna elements.

12. A radar receiver according to claim 11 comprising a further processing stage the further processing stage being adapted to serve at least four second stage processing modules and 64 antenna elements.

13. A radar receiver according to claim 3 wherein said calibration means is adapted to provide a common calibration signal comprising at least one of: a pre-determined amplitude, a pre-determined frequency, a predetermined delay; and/or a pre-determined phase.

14. A radar receiver according to claim 3 wherein said calibration means comprises a feed connection (e.g. a pad) via which said common calibration signal can be input to said calibration means.

15. A radar receiver according to claim 14 wherein said feed connection is provided on a common antenna substrate on which said antenna elements are provided,

16. A radar receiver according to claim 14 wherein said feed connection is provided in one of said first and second processing stages.

17. A radar receiver according to claim 14 wherein said feed connection (e.g. a pad) is connected to each coupler by a respective calibration path each said calibration path being substantially the same length as each other calibration path.

18. A radar receiver according to claim 3 wherein said calibration means comprises a substantially planar calibration network.

19. A radar receiver according to claim 3 wherein each said coupler is arranged for weak coupling to its respective antenna element.

20. A radar receiver according to claim 3 wherein said calibration means comprises a hierarchy of calibration branches extending from the feed connection to each coupler.

21.-47. (canceled)
